(19) United States
(12) Patent Application Publication
(10) Pub. No.: US 2016/0290278 A1
(43) Pub. Date: Oct. 6, 2016

(54) IMPROVED THERMAL MANAGEMENT OF COMBUSTION ENGINES

(71) Applicant: FRICSO LTD., Tirat Hakarmel (IL)

(72) Inventor: Shai AVIEZER, Moshav Shilat (IL)

(21) Appl. No.: 15/038,461

(22) PCT Filed: Nov. 26, 2014
(86) PCT No.: PCT/IL2014/051027

§ 371 Date: May 22, 2016

Related U.S. Application Data
(60) Provisional application No. 61/908,777, filed on Nov. 26, 2013.

(51) Int. Cl. F02F 1/20; B24B 5/06

(52) U.S. Cl. CPC F02F 1/20; B24B 5/06

(57) ABSTRACT

A method of improving the reflectivity of a surface of an internal combustion engine, the internal combustion engine having a cylindrical or non-cylindrical internal wall of an internal combustion chamber in which one or more pistons move and in which combustion occurs, the method comprising polishing a surface of the internal combustion chamber, said surface during use of the internal combustion engine exposed to combustion, said polishing effective to increase a reflectivity of the surface. The surface may include a first zone not traversed by the one or more pistons and polished in a first manner (pressure, time, electrical current density or voltage) to yield a first reflectivity and a second zone traversed by the one or more pistons polished in a different manner and yielding a second reflectivity.

### FIELD AND BACKGROUND OF THE INVENTION

The present invention relates to apparatuses and methods for increasing efficiency of internal combustion engines.

Efficiency of internal combustion engines is of profound global importance economically and ecologically as current world fleet of cars, motorcycles and trucks stretches rapidly over 1,000 million operative units (2013). Much effort has been devoted to numerous improvements in the structure and control of the internal combustion engine.

It is well known in the art that the ratio of useful mechanical energy at crank to the potential caloric value of the fuel that propels the engine goes below 0.45 in most advanced internal combustion engine to date and typically below 0.35. Substantial part of the remaining wasted energy (40-50% of the remaining) is lost to the coolants and in some degree to the lubricant.

The heat loss from the combustion directed to the combustion chamber walls is as a result of two principal mechanisms—30-35% by radiation and the rest by convection from the combustion products and friction. As of the nature of reciprocal combustion engines the piston typically will receive much of the radiative heat flux ˜50%, the engine head & valves ˜30% and the cylinder ˜20% as it is gradually exposed throughout the cycle while the combustion gases lowers their temperature somewhat.

There is a compelling need for a more efficient internal combustion engine, and particularly one that also has low emissions.

### SUMMARY OF THE INVENTION

One aspect of the present invention is a method of improving the reflectivity of a surface of an internal combustion engine, the internal combustion engine having a cylindrical or non-cylindrical internal wall of an internal combustion chamber in which one or more pistons move and in which combustion occurs, the method comprising polishing a surface of the internal combustion chamber, said surface exposed to combustion during use of the internal combustion engine, said polishing effective to increase a reflectivity of the surface.

Another aspect of the present invention is a component of an internal combustion engine, the engine having a chamber that has a cylindrical or non-cylindrical internal wall and has one or more pistons moving within the chamber, the component including one of the following: (i) an internal combustion chamber having an internal wall including a polished surface exposed to combustion during operation of the engine, (ii) one or more pistons that have a polished surface exposed to combustion during operation of the engine, (iii) a valve having a polished surface exposed to combustion during operation of the engine and (iv) an engine head having a polished surface exposed to combustion during operation of the engine, said polished surface having a reflectivity of at least 45%.

The materials of construction of the components of the internal combustion engine may differ considerably, nevertheless substantial improvement in reflectivity may be gained by polishing the surfaces exposed to combustion and in some cases also coating of said surfaces.

According to further aspects of the present invention the treated surfaces could be coated during the polishing stage with thin layer(s) in the submicron to nanometric scale that will allow further improvement of the reflective properties or improve their durability to the operation conditions as well as improve tribological performance when applicable.

According to further aspects of the present invention, said coatings could be applied after such polishing/lapping treatment and be applied by Chemical vapor deposition, Physical vapor deposition PVD and reactive or sintered coatings that may allow such further improvements.

According to yet another aspect of the present invention, the areas of the piston area exposed to the combustion will be polished/lapped in order to increase reflectivity to at least 45%, and more preferably significantly higher, for example at least 80%.

According to yet another aspect of the present invention, the piston surfaces exposed to the combustion in the combustion chamber will be characterized by surface quality of at least N4-N3 and more commonly N2-N1 and preferably for high end applications by N1-N0.

According to a yet further aspect of the present invention, polishing piston surface exposed to combustion chamber is performed by using a tool having conformal surface and abrasive paste. Said paste may contain a plurality of abrasive particles and combination of etching compound, binding agents & thickeners and polymer particles.

According to yet another aspect of the present invention the lapping of the piston cross cut exposed to the combustion chamber is made using a polymer tool having Young modulus lower than 20 GPa and conformal structure that will allow deformation according to work piece geometry. Such tool may contain supporting layers of yet same polymer or softer polymer or mechanically supported by compliant mechanism either made of the polymer it self or based on spring like support to segments of said polymer working surface. Said lapping tool will be activated at speeds that will be below 10 m/sec at initial stage of processing and below 17.5 m/sec at final stage of processing and pressed to the surface of the work piece with pressure higher than 0.005 Mpa at initial stage and lower than 0.35 MPa at final processing stage . Said work piece will be applied with abrasive paste that will contain inorganic abrasive particles and may contain combination of etching compound, binding agents & thickeners and polymer particles.

According to yet another aspect of the present invention, the piston treated surface will be coated with thin layer of one, or a combination of the following materials: polymer bonded composite of sub-micron particles, glass, silica , sol-gel based coatings , silicon coatings, titanium dioxide thin layers, nickel , chrome, gold or silver or platinum or combinations thereof. Such layers may range from 15 nm-65 um in order to optimize both optical and durability aspects as well as cost aspects and more typically from 15 nm-20 um.

According to yet another aspect of the present invention, pistons are treated in a feed through machine. Whereas in such device the piston gains rotational spin from the feeding mechanism and the pistons are pressed against the polishing/lapping tool. The said tool may have yet another vector of speed or spin allowing optimization of the polishing/lapping process.

According to yet another aspect of the present invention the areas of the engine head exposed to the combustion chamber will be polished/lapped in order to improve their reflectivity.

According to yet another aspect of the invention, the lapping of the piston cross cut exposed to the combustion chamber is made using a polymer tool having Young modulus lower than 20 GPa and conformal structure that will allow deformation according to work piece geometry. Such tool may contain supporting layers of yet same polymer or softer polymer. Said lapping tool will be activated at speeds that will be below 10 m/sec during initial stage of polishing processing and below 17.5 m/sec at final stage of processing and pressed to the surface of the work piece with pressure higher than 0.005 Mpa at initial stage and lower than 0.35 MPa at final processing stage. Said work piece will be applied with abrasive paste that will contain in-organic abrasive particles and may contain combination of etching compound, binding agents & thickeners and polymer particles.

According to yet another aspect of the invention the piston treated surface will be coated with thin layer of one , or combination of the following materials : glass, silica , sol-gel based coatings , silicon coatings, Titanium dioxide thin layers, Titanium nitride , Nickel , Chrome, Gold or Silver or Platinum or thin layer of diamond like coating. Such layers range from 25 nm-50 um in order to optimize both optical and durability aspects as well as cost aspects .

According to another aspect of the invention, the polishing processing stage is performed on a working station having at least one of said polishing tool and automatic mechanism to deploy/replace polishing pads or strips or applying lapping compound on the work piece.

According to further aspects described in the present invention, reflective properties of cylinders or liners used in internal combustion engines after the honing process (or similar process that finely defines the pass of a piston along the combustion chamber walls) may be altered to improve their reflectivity by mechanical polishing or lapping of the surface, chemical & mechanical polishing/lapping (CMP), electro polishing and combination thereof.

According to further aspects of the present invention, the combustion chamber walls within a cylinder may be coated during the polishing stage with thin layer(s) in the nanometric scale that will allow further improvement of the reflective properties or improve their durability to the operation conditions.

According to further aspects of the present invention, said coatings could be applied after such polishing/lapping treatment and be applied by Chemical vapor deposition(CVD), physical vapor deposition (PVD), polymeric layer, composite layers of polymer and nano/sub micron particles of metals and metal oxides, or reactive or sintered coatings that may allow such improvements.

According yet to another aspect of the present invention, the area of a treated cylinder will have a ratio between the area, having surface quality of N2 or less (i.e. N1 or N0) to surfaces having a surface quality of N3 and above, is higher than 0.5 and more preferably and commonly higher than 1.5. For this purpose one considers the honing marks remaining after polishing to define segments of the polished surface and in measuring this ratio, only segments of 30 square microns of more are counted.

According to a yet further aspect of the present invention, polishing cylinder exposed to combustion chamber is performed by using a tool having conformal surface and abrasive paste .Said paste could contain plurality of abrasive particles and combination of water, etching compound, water soluble binding agents & thickeners and polymer particles.

According to a yet further aspect of the present invention, polishing cylinder exposed to combustion chamber is performed by using a tool having conformal surface and abrasive paste .Said paste is comprised of plurality of abrasive particles and combination of water, surfactants, etching compound, oil soluble binding agents & thickeners and polymer particles.

According to yet further aspect of the present invention, polishing cylinder exposed to combustion chamber is performed by using a tool having conformal surface and abrasive paste. Said paste could contain plurality of abrasive particles and combination of, etching compound, oily binding agents & thickeners and polymer particles.

According to yet another aspect of the present invention, the lapping of the cylinder area exposed to the combustion chamber is made using a polymer tool having Young modulus lower than 20 GPa and conformal structure that will allow deformation according to work piece geometry. Such tool may contain supporting layers of yet same polymer or softer polymer. Said lapping tool will be activated at speeds that will be below 10 m/sec and pressed to the surface of the work piece with pressure higher than 0.005 Mpa. Said work piece will be applied with abrasive paste that will contain in-organic abrasive particles and may contain combination of etching compound, binding agents & thickeners and polymer particles.

According to yet another aspect of the present invention, the piston treated surface will be coated with thin layer of one, or combination of the following materials: glass, silica, sol-gel based coatings, silicon coatings, titanium dioxide thin layers, nickel, chrome, gold or silver-silver rhodium or platinum. Such layers may range from 25 nm-65 um in order to optimize both optical and durability aspects as well as cost aspects .

According to yet another aspect of the present invention, polishing of the cylinder area exposed to the combustion chamber is made using a conformal, soft polymer tool made of foam, fiber, soft thin polymer layers or combination thereof. Such tool may contain supporting layers of yet same polymer or softer polymer. Said polishing tool will be activated at speeds that will be below 25 m/sec and pressed to the surface of the work piece with pressure lower than 0.05 Mpa. Said workpiece will be coated with abrasive paste or sprayed with thin layer of slurry that will contain in-organic abrasive particles and may contain combination of water , surfactants ,etching compound, oily or water soluble binding agents & thickeners and polymer particles. Such slurry could contain volatile material that upon its evaporation before or during the treatment will increase the viscosity of the abrasive paste and potentially promote viscoelastic behavior of said paste. According to yet another aspect of the present invention the formulation of the abrasive paste or slurry may be added with organic materials that will promote viscoelastic properties of the same under high shear rate of the abrasive carrier material/tool during the polishing/lapping stage.

According to yet another aspect of the present invention, the cylinder treated surface will be coated with thin layer of one, or combination of the following materials: polymer layers , polymer bonded composite having sub micron fillers, sol-gel based coatings , silicon coatings, titanium dioxide thin layers, nickel, chrome, gold or silver-silver rhodium or platinum. Such layers range from 15 nm-65 um in order to optimize both optical and durability aspects as well as cost aspects .

According to yet another aspect of the present invention, the cylinder treated surface will be coated with thin layer of one, or combination of the following materials: polymer layers, sol-gel based coatings and particulate material of the sub micron scale of one of metal oxides or metal sulfides or metal sulfates as well as steel sub micron particles, molybdenum bi-sulfide, graphite, graphene based coatings, H-Boron Nitride. Such layers range from 15 nm-6 um in order to optimize both optical, durability and tribological properties as well as relate to cost aspects.

According to yet another aspect of the present invention, cylinders are treated by tool attached to a honing machine. Said tool could be of the nature of polymer lapping device as described in the art.

According to yet another aspect of the present invention, cylinder liners that are not joined to the engine block by casting process could be treated in a feed through machine by said tool and where as said tool could have either reciprocal movement and rotational movement and where as said liner can be rotated by said feed through machine in order to promote productivity ;and where as said system has at least one mechanical degree of freedom along the tool attachment to allow alignment of cylinder and tool rotational axes.

According to yet further aspect of the present invention, achieving substantial degree of increase in reflectivity of the valves seat area exposed to the internal volume of the combustion chamber is done by process comprised from the following : initial milling or more preferably grinding of the seat area and a second polishing stage preformed by using a tool having conformal surface and abrasive paste .Said paste could contain plurality of abrasive particles and combination of etching compound , binding agents & thickeners and polymer particles.

According to yet another aspect of the present invention, the lapping of the valve seat cross cut exposed to the combustion chamber is made using a polymer tool having Young modulus lower than 20 GPa and structure preferably suited to seat geometry yet conformal under pressures higher than 0.005 MPa that will allow deformation according to work piece geometry and required localized pressure regime between the tool & work piece surfaces. Such tool may contain supporting layers of yet same polymer or softer polymer. Said lapping tool will be activated at speeds that will be below 10 m/sec and pressed to the surface of the work piece with pressure higher than 0.005 Mpa. Said work piece will be coated with abrasive paste or sprayed with thin layer of slurry that will contain in-organic abrasive particles and may comprise of plurality of abrasive particles types of various size distribution and varying ratios according to surface quality and valves material properties and may contain combination of water , surfactants ,etching compound, oily or water soluble binding agents & thickeners and polymer particles.

According to yet another aspect of the present invention, polishing of the Valve area exposed to the combustion chamber is made using a conformal, soft polymer tool made of foam, fiber , soft thin polymer layers or combination of thereof.

Such tool may contain supporting layers of yet same polymer or softer polymer. Said polishing tool working surface will comprise of abrasive particles and binding matrix and will be activated at speeds that will be below 25 m/sec and pressed to the surface of the work piece with pressure lower than 0.05 Mpa. Alternatively, said work piece will be coated with abrasive paste or sprayed with thin layer of slurry that will contain in-organic abrasive particles and may contain combination of water, surfactants, etching compound, oily or water soluble binding agents & thickeners and polymer particles.

According to yet another aspect of the present invention, the formulation of the abrasive paste or slurry may be added with organic materials that will promote viscoelastic properties of the same under high shear rate of the abrasive carrier material/tool during the polishing/lapping stage.

According to yet another aspect of the present invention, the valve treated surface will be coated with thin layer of one, or combination of the following materials: glass, silica, sol-gel based coatings, silicon coatings, titanium dioxide thin layers, nickel, chrome, gold or silver or platinum or diamond like thin layer coating (DLC). Such layers range from 10 nm-85 um in order to optimize both optical and durability aspects as well as cost aspects.

According to yet another aspect of the present invention, valves are treated in a feed through machine. In such feed through machine the valves gain rotational spin from the feeding mechanism and are pressed against the polishing/lapping tool. Said tool can have yet another vector of speed or spin allowing optimization of the polishing/lapping process.

According to yet another aspect of the present invention, the areas of the valve cross section exposed to the combustion chamber will be polished/lapped in order to increase reflectivity of said surface to at least 45%, and more preferably to 60% or 75% or 90%, and surface quality classification of N2 or more commonly and preferably N1-N0.

According to another aspect of the present invention the polishing/lapping processing stage of the valves is performed on a working station having at least one of said polishing tool and automatic mechanism to deploy/replace polishing pads or strips or applying lapping compound on the work piece.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a schematic, partial cross sectional view of a prior art lapping arrangement, used for conditioning a metal tribological working surface;

FIG. 2 is a schematic, partial cross sectional view of the lapping arrangement of FIG. 1, used to condition a multiple phase or composite working surface having phases of varying degrees of hardness;

FIG. 3a is a schematic view of combustion chamber having cylinder 1103, piston 1102 and engine head 1104 and valves 1101, in accordance with one embodiment of the present invention;

FIG. 3b is a schematic view of the indentation point of beam 1007 with intensity Iₒ and reflected beam of light I_{ref} 1008 with lower intensity, in accordance with one embodiment of the present invention;

FIG. 4 is a schematic, partial cross section view of lapping arrangement used in prior art to treat a multiple-phase tribological working surface;

FIG. 4A is a schematic, top view of an exemplary particle of the soft phase of the work piece as presented in prior art, after undergoing one a lapping process in accordance with one embodiment of the present invention;

FIG. 5 is a photograph of treated cast iron cylinder 1003) embedded in aluminum block and showing two reflections—a main reflected image of source (1009) and a secondary image 1110 of the crank bearing reflection;

FIG. 6 is a schematic drawing of several internal combustion chambers, in accordance with one embodiment of the present invention;

FIG. 7 is schematic drawing of an internal combustion chamber, in accordance with one embodiment of the present invention;

FIG. 8 is a schematic drawing of an internal combustion chamber 10A of a Wankel engine and including a rotary piston 40a, in accordance with one embodiment of the present invention;

FIG. 9 is a graph of reflectivity depending on the wavelength (of the light generated during combustion) for a surface of an aluminum piston exposed to combustion, in accordance with one embodiment of the present invention;

FIG. 10 is a graph of reflectivity depending on wavelength for a surface of a sample cast iron work piece, in accordance with one embodiment of the present invention;

FIG. 11 is a graph of reflectivity depending on wavelength for a surface of a sample noncoated D2 steel work piece, in accordance with one embodiment of the present invention;

FIG. 12 is a graph of reflectivity depending on wavelength for a surface of a polished and thinly coated aluminum piston, in accordance with one embodiment of the present invention;

FIG. 13 is a graph of roughness of a cross-section of an uncoated honed surface of an internal wall of cylindrical chamber, before and after polishing (including the honing marks), in accordance with one embodiment of the present invention;

FIG. 14 is a photograph of a typical uncoated honed surface of an internal wall of cylindrical chamber, before and after polishing (including the honing marks), in accordance with one embodiment of the present invention; and

FIG. 15 is a flow chart showing a method of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method and apparatus for improving the reflectivity of a surface, for example a surface of an internal combustion engine. The surface may be a surface of a reciprocating internal combustion engine having a cylindrical wall, for example an internal wall or it may be an internal wall surface of a non-cylindrical internal combustion chamber such as a Wankel engine having rotary pistons. In either case, one or more pistons move within the internal combustion chamber of the internal combustion engine and combustion occurs in this chamber. The method may include polishing a surface of the internal combustion chamber, said surface during use of the internal combustion engine exposed to combustion, said polishing effective to increase a reflectivity of the surface, for example to 80% or to other percentages. In addition to polishing the method may include applying a thin coating to the surface which together with the polishing may increase the reflectivity still further, for example to 90% or to other percentages. The surface may be a tribological surface such as an internal wall of a chamber in which the one or pistons move, or non-tribological surfaces such as a “top” surface of one or more pistons (the “top” surface” of the piston refers to. the piston surface exposed to combustion), a surface of one or more valves (for example stem valves) and/or a surface of an engine head. The surface exposed to combustion may have a first zone that does not traverse the one or more pistons and a second zone that traverses the one or more pistons, or subzones thereof, wherein the polishing or coating is different in each zone or subzone and the resulting reflectivity is different in the various zones or subzones. In certain preferred embodiments, the polishing may be performed using a polymer tool, as described more fully below.

In contrast to prior art methods and apparatuses for increasing the efficiency of an internal combustion engine, which address the structure and/or control of the internal combustion engine, the present invention may improve efficiency by improving thermal management of the internal combustion engines, thereby increasing power and providing other advantages. For example, the present invention may fundamentally change the thermal management within the combustion chamber by altering the reflective properties of an internal wall surface and lowering the heat loss. In further contrast to prior art methods and apparatuses for improving the efficiency of the internal combustion, which necessitate a very costly re-design of the engine components and in some cases even a new infrastructure for an assembly line for such new engine design, the improved engine efficiency that may be achieved by the present invention may not require re-designing the engine. The efficiency improvement may be achieved in an industrially feasible way while maintaining the essential aspects of current design. In further contrast to the prior art efficiency improvement solutions, which although they increase efficiency do not also lower emissions, the present invention may not only improve efficiency but also lower level of emissions. The present invention may also lower the wear of the engine. In still further contrast to prior art efficiency improvement solutions, which help the engine but do not improve peripheral engine sub-systems, the present invention not only may improve engine efficiency but may also improve one or more peripheral engine sub-systems. For example, the workload of the cooling system may be reduced from the improved thermal management of the engine.

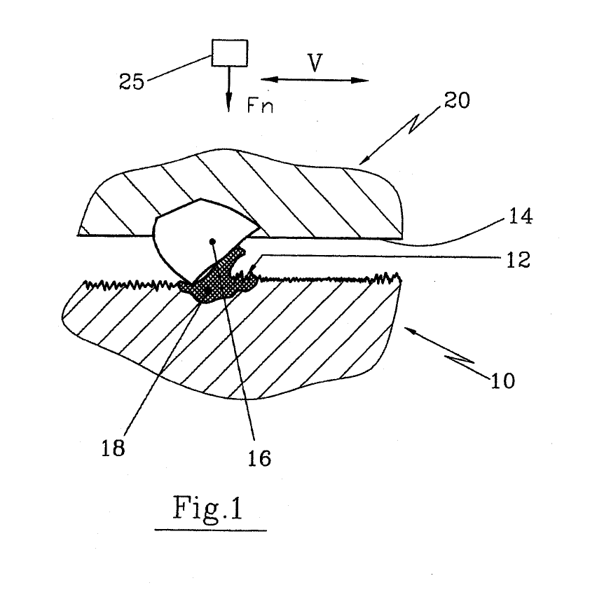

FIG. 1 schematically presents a lapping of the prior art, used for conditioning a metal tribological working surface 12. Working surface 12, disposed on a workpiece 10, faces a contact surface 14 of a lapping tool 20 and is separated by a nominal distance therefrom. Abrasive particles such as abrasive particle 16 are disposed within a paste or slurry situated between contact surface 14 and working surface 12. Working surface 12 and contact surface 14 are made to move in relative motion by a mechanism 25. This relative motion has a velocity of instantaneous magnetite V. Mechanism 25 also exerts a load Fn (or a pressure) that is preferably substantially normal to contact surface 14 and working surface 12. Those skilled in the art appreciate that mechanism 25 may be chosen from various known and commercially available mechanisms for use in conjunction with lapping systems.

Under load Fn, abrasive particles such as abrasive particle 16 are partially embedded in contact surface 14, and to a lesser extent, in working surface 12. At relative velocity V, and under load Fn, abrasive particles such as abrasive particle 16 lap working surface 12, gouging out material therefrom, so as to effect the desired reduced roughness of working surface 12. As material is gouged out, a plastic deformation zone 18 is formed on working surface 12.

In conventional processes for lapping metals, contact surface 14 is made of a material having a hardness that is lower than the hardness of working surface 12, and/or has a hardness that is at least the hardness of Aluminum.

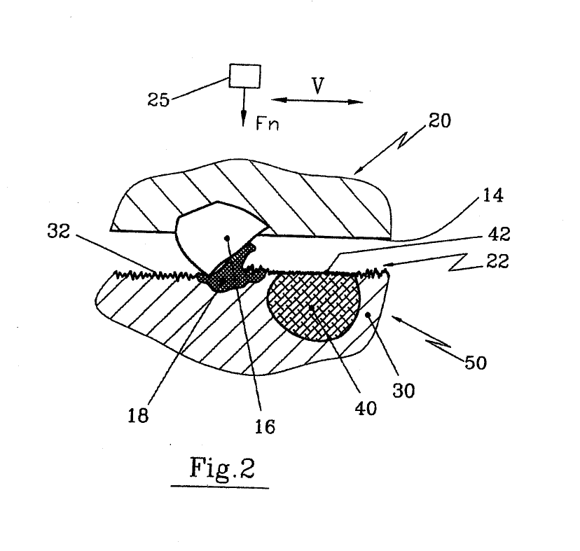

FIG. 2 schematically presents the prior art lapping technology of FIG. 1, used for conditioning a multiple phase or composite tribological working surface 22 having phase of varying degree of hardness, by way of example, a relatively hard phase 30 and a relatively soft phase 40. Soft phase 40 may be present in various shapes, e.g., in the form of spheres, spheroids, lamellae or flakes, strips, streaks, etc.

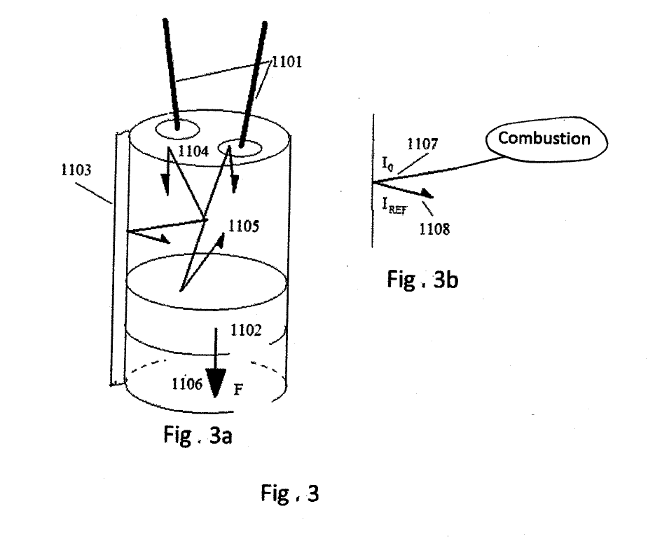

FIG. 3a is a schematic view of combustion chamber having cylinder 1103, piston 1102 and engine head 1104 and valves 1101. Irradiation initiated from the combustion (1005) is represented for illustrative reasons only as point source, is passing through the medium of the combustion species and hits the walls of the combustion chamber and partly reflected of thereof. The reflected light is thus further absorbed by the combustion species (including soot, water, partly oxidized HC and peroxides of thereof, HC of aliphatic and aromatic and poly-aromatic nature as well as nitrogen oxides and Sulphur compounds that are ever fewer with ECO-fuels) and thus light (IR, Visible, UV) is absorbed by the chemical species having wide energy absorption wave length window. Such absorbance of the energy would promote higher temperature and pressure compared to the equivalent state where reflectivity of the combustion chamber walls is low. There are ample positive and beneficial outcomes of such improved thermal management. The most evident and easily understood is that once a specific portion of fuel is injected into the combustion chamber, greater pressure will be applied on the piston as combustion progresses and gasses expand. Thus, the net outcome will be net higher power of the engine per specific operation condition and evidently higher efficiency. Alternatively, it could be deduced as well that in order to receive the same pressure on the piston (1002) and thus the same useful mechanical energy, i.e. engine power, smaller quantities of fuel should be introduced to the combustion chamber—to put it simply, this means greater fuel efficiency. A further benefit could be the lower thermal load on the cooling system and thus size and weight reduction which again favor such greater fuel efficiency. An additional beneficial aspect of the combination of said polymer lapping, a process known in the prior art for its tribological benefits, is the combined tribological and enhanced thermal management by altering the lapping conditions and paste composition .Under such conditions, the formation of greater plateau/mirror-like surfaces is enhanced while the polymeric nanometric layer existence and thickness and composition could be modified. In addition, the lubricant layer forming on the cylinder walls is thus thinner and less absorbing. The net combined effect is lower absorbance of the radiation i.e. smaller energy loss and upon lubrication system design lower lubricant consumption. Yet an additional benefit of the process refers to the period just after ignition of the engine. During the first few minutes, when there is a relatively low temperatures of the engine and combustion gases, the greater portion of the HC emissions and soot is forming. Thus the increased thermal efficiency at that stage leads to shorter and less severe contamination formation.

FIG. 3b is a schematic view of the indentation point of beam 1007 with intensity I₀ and reflected beam of light I_{ref} 1008 with lower intensity.

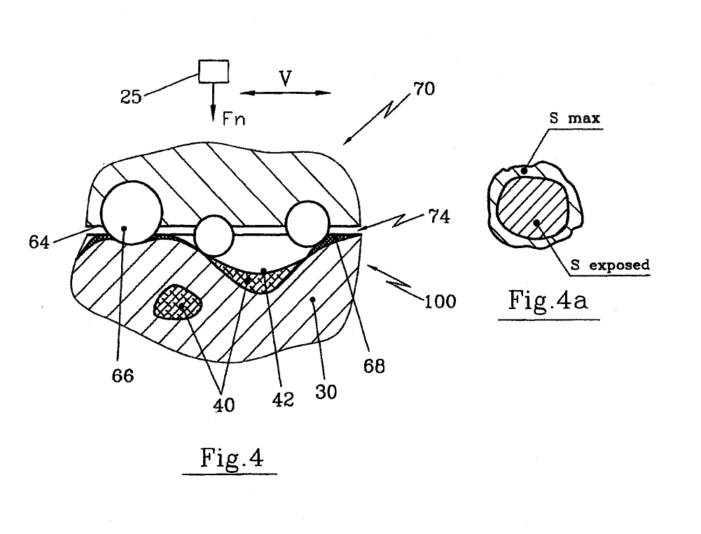

FIG. 4 represents schematically the prior art relevant for the lapping of multiple phase alloys or composites. A conventional lapping mechanism such as lapping mechanism 25 may be used in accountancy with a lapping system 100 of the present invention. Shown in the schematic, cross-sectional view is a contact surface 64 of a lapping tool 70, in the process of lapping a multiple phase tribological workpiece 100 (MPTWP), to produce a treated multiple phase working surface such as MPTWP working surface 74. Contact surface 64 is an organic, polymeric surface, or preferably includes an organic, polymeric material in the surface. By treating MPTWP the reflective properties of said workpiece are modified to promote improved reflectivity of IR, Vis & UV irradiation.

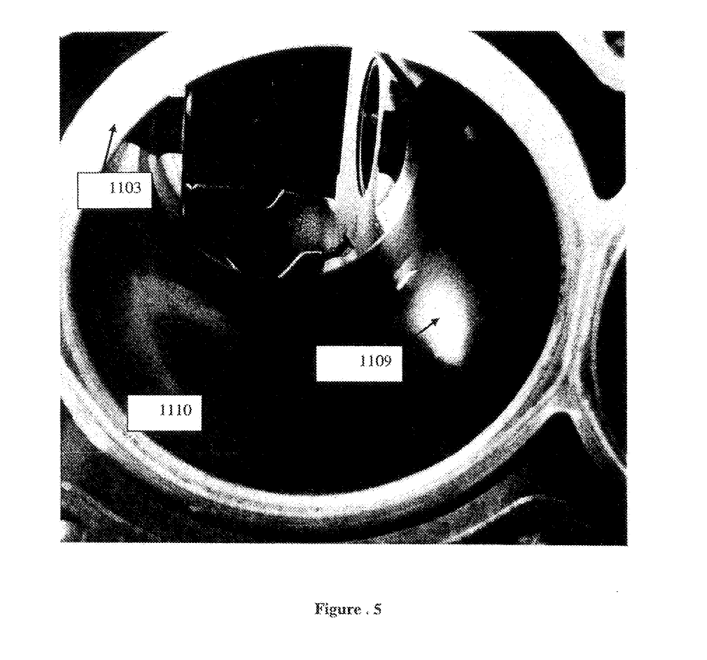

FIG. 5 is a photograph of a polymer lapped treated cast iron cylinder. The cylinder 1103 is embedded in an aluminum cast forming the engine block. The cylinder, after it underwent a honing process, was polymer lapped to form tribological working surface that are of high reflective properties as indicated by the reflections of light source 1109 and secondary image 1110. The tuning of the surface properties and emphasis of each of the desired surface properties are made by modification of processing conditions.

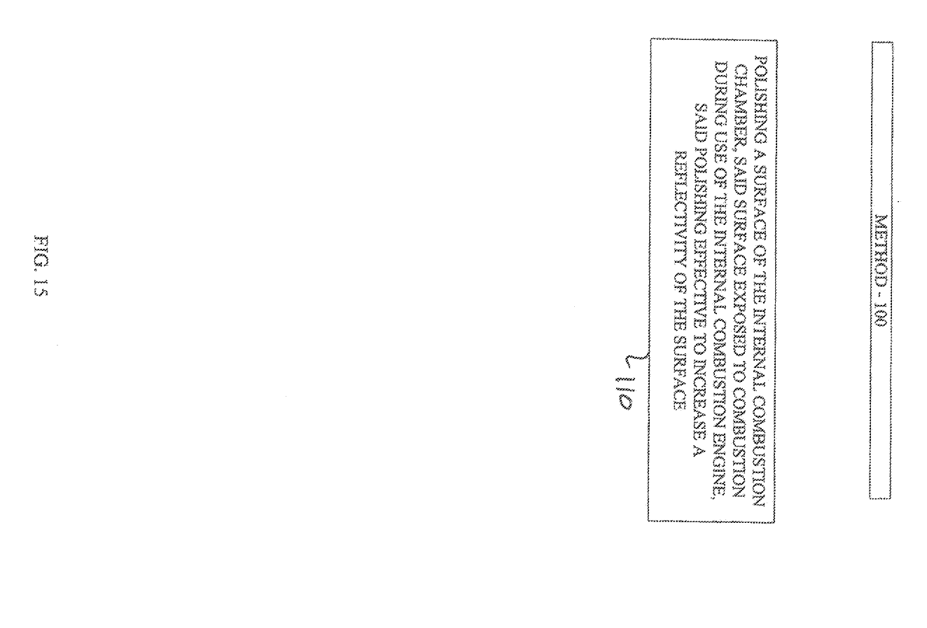

As shown in the flow chart of FIG. 15, the present invention may be described as a method 100 of improving the reflectivity of a surface of an internal combustion engine, the internal combustion engine having a cylindrical or non-cylindrical internal wall of an internal combustion chamber in which one or more pistons move and in which combustion occurs. Method 100 may have a step 110 of polishing a surface of the internal combustion chamber, wherein said surface is exposed to combustion during use of the internal combustion engine. The said polishing may be effective to increase a reflectivity of the surface. The one or more pistons 1102 referred to herein include both reciprocating pistons and rotary pistons (i.e. of a Wankel engine)

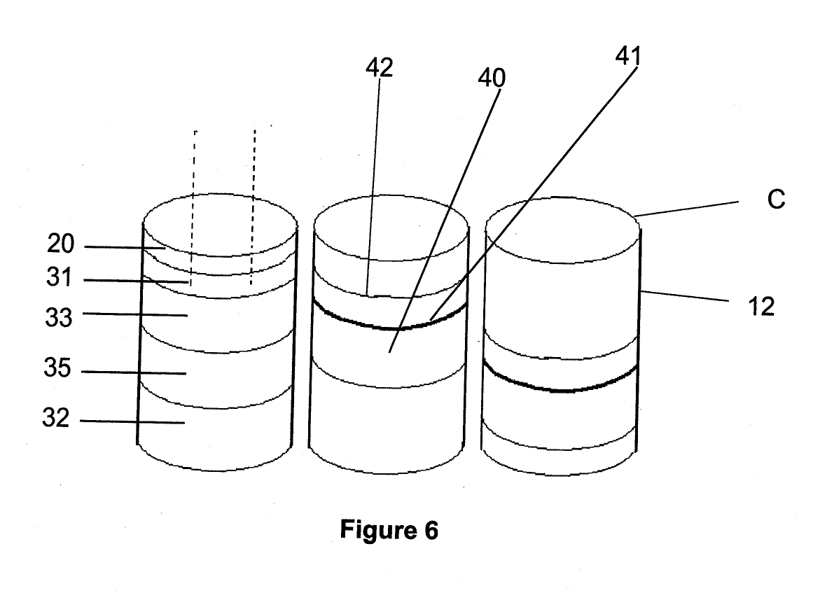

The polishing of the surface may comprise polishing the cylindrical internal wall of the internal combustion chamber or it may comprise polishing the non-cylindrical internal wall of a Wankel engine or other engines having non-cylindrical internal combustion chambers. For cylindrical internal walls, the method may further comprise polishing a first zone 20 (FIG. 6) of the surface in a first manner, for example using a first amount of pressure for a first length of time. First zone 20 is an area of the surface of the cylindrical internal wall 12 that is exposed to the combustion—at least at times during operation—but that is not traversed by the one or more pistons. Hence, first zone 20 requires considerations of reflectivity but not tribological considerations. Since typically there are multiple cylinders for multiple pistons, the first zone 20 may include the area of each chamber that is exposed to combustion but not traversed by the piston of that chamber. Second zone 30 (FIG. 6) is an area of the surface of the cylindrical internal wall 12 that is exposed to combustion and is traversed by the one or more pistons 1102. Second zone 30 may have a subsection 31, for example an uppermost subsection closest to first zone 20, which is exposed to combustion but only when the one or more pistons move down below subsection 31 (and not exposed to combustion at other times of operation).

Method 100 may further comprise polishing a second zone 30 of the surface, said second zone 30 being a zone that is traversed by the one or more pistons, in a different manner from the manner in which the first zone was polished (or in certain preferred embodiments coated in a different manner that the manner in which the thin coating is applied to the first zone), for example using an amount of pressure greater or lesser than the first amount of pressure or using the first amount of pressure for a length of time longer or shorter than the first length of time, wherein length of time refers to length of time that the surface is polished by a tool, or using a different electrical current density or voltage (whether or not the pressure and/or time are the same).

The second zone 30 may be comprised of one or more subzones, for example a first subzone 33, a second subzone 35, or still further subzones. The uppermost subzone 31 of second zone 30 may be polished the way the first zone is polished but uppermost subzone 31 may be coated differently. Zone 32 denotes an area that is not exposed to combustion because the piston 1102 is located there. Since it is not exposed to combustion it is not considered part of second zone 30. Accordingly, tribological considerations but not reflectivity considerations apply there with respect to treatment of the surface at zone 32.

As seen from FIG. 6, the first and second zones 20, 30 are separate by a plane that is substantially perpendicular to the inner cylindrical wall of the cylindrical chamber.

For example, the first amount of pressure applied to the first zone during polishing may be 20% or at least 20%, 30% or at least 30%, 40% or 40%, 50% or at least 50%, 60% or at least 60%, 70% or at least 70%, 80% or at least 80%, 90% or at least 90% or 100% or at least 100% greater than the amount of pressure used to polish the second zone. In another example, method 100 may comprise polishing a first subzone of the second zone with a different amount of pressure or with a different electrical current density or voltage than used with the polishing of a second subzone of the second zone. For example, method 100 may further comprise polishing a first zone of the surface using a first amount of electrical current density or voltage for a first length of time, the first zone not traversed by the one or more pistons, and polishing a second zone of the surface traversed by the one or more pistons either using an amount of electrical current density or voltage greater or lesser than the first amount of electrical current density or voltage or using the first amount of electrical current density or voltage for a length of time longer or shorter than the first length of time.

In addition to polishing the surface exposed to combustion, method 100 may also involve applying a thin coating of one or a combination of the following materials: polymer bonded composite of sub-micron particles, glass, silica, sol-gel coating, silicon, titanium dioxide, nickel, chrome, gold, silver, platinum and particles thereof. There are two possible forms of titanium dioxide: anataze (which is reflective and reactive so as to enhance formation of free radicals) and rutile (which is reflective and hinders formation of free radicals and thus induces a stabilizing effect for organic materials such as the lubricant). In certain preferred embodiments, the thin coating utilizes in whole or in part anataze in certain places of the surface and utilizes in whole or in part rutile in other places. For example, in places where lubricant is present rutile is used and in places where lubricant is not present anataze is used (alone or in combination with the other materials).

The thin coating may have a thickness of between 15 nanometers and 65 microns. In other preferred embodiments, the thin coating has a thickness of between 15 nanometers and 5 microns, or between 15 nanometers and 1 micron. In still other preferred embodiments, the thin coating has a thickness of between 15 nanometers and 0.8 microns, or between 15 nanometers and 0.5 microns, or in still other preferred embodiments, of between 35 nanometers and 5 microns, between 35 nanometers and 1 micron, between 35 nanometers and 0.8 microns, or between 35 nanometers and 0.5 microns.

The polishing of the cylindrical internal wall of the internal combustion engine may be such as to have, between honing marks left on the cylindrical internal wall after the polishing, a roughness, Ra, of less than 0.05 microns and an RΔq of less than 0.03. In other preferred embodiments, the polishing of the cylindrical internal wall of the internal combustion engine may be such as to have, between honing marks left on the cylindrical internal wall after the polishing, a roughness, Ra, of less than 0.025 microns and an RΔq of less than 0.03. In still other preferred embodiments, the polishing of the cylindrical internal wall of the internal combustion engine may be such as to have, between honing marks left on the cylindrical internal wall after the polishing, a roughness, Ra, of less than 0.01 microns and an RΔq of less than 0.02.

Polishing the surface may comprise polishing the non-tribological surface of the one or more pistons (i.e. a “top” surface of the piston exposed to combustion), a stem valve and/or an engine head of the internal combustion chamber.

Method 100 may further comprise polishing the surface of the one or more pistons exposed to combustion so as to increase the reflectivity of the polished surface, without applying a thin coating, to more than 45%, in other preferred embodiments to more than 60%, in still other preferred embodiments to more than 75%, in still other preferred embodiments so as to increase the reflectivity to more than 90%, and in still other preferred embodiments to increase the reflectivity of the polished surface to more than 95%.

The polishing of the surface may be by mechanical, chemical or electro polishing or lapping of the surface or any combination thereof. If the surface is of the one or more pistons exposed to combustion, method 100 may further comprise polishing the surface of the one or more pistons exposed to combustion by using a tool having conformal surface that deforms according to work piece geometry. In a further preferred embodiment, the tool may have abrasive paste, said paste containing abrasive particles and containing any combination of etching compound, binding agents, thickeners and polymer particles. In still other preferred embodiments, the tool may be used so as to apply electrical current to the surface. This is for the purpose of increasing polishing speed and improving surface quality such as roughness. Polishing the surface of the one or more pistons exposed to combustion may be by using a polymer tool having Young modulus lower than 20 GPa and having conformal surface that deforms according to work piece geometry structure. The polymer tool may contain supporting layers of activated at a speed below 10 m/sec at an initial stage (defined to the processing time until 90% of the material to be removed has been removed) and below 17.5 m/sec at a final stage, said polymer tool pressed to the surface with pressure higher than 0.005 Mpa at the initial stage and lower than 0.35 MPa at the final stage (defined to be the processing time from after the initial stage until the end of the processing time , i.e. from 90% to 100%)

The present invention may also be described as a component 10 of an internal combustion engine, the engine having an internal combustion chamber 1103 (which chamber may be a cylindrical chamber for a reciprocating engine or may be a non-cylindrical chamber such as in a Wankel engine). Chamber 1103 may have a cylindrical or non-cylindrical internal wall 15 and has one or more pistons 1102 moving within the chamber 1103.

The component 10 may be defined to include one (or in other preferred embodiments one or more) of the following elements of the internal combustion engine: (i) an internal combustion chamber 1103 (or more than one) having an internal wall including a polished surface exposed to combustion during operation of the engine, (ii) one or more pistons 1102 including a polished surface exposed to combustion during operation of the engine, (iii) one or more valves 1101 (for example a stem valve 1101 of each chamber 1103) having a polished surface exposed to combustion during operation of the engine and (iv) an engine head 1104 having a polished surface exposed to combustion during operation of the engine, said polished surface having a reflectivity of at least 45%. In other preferred embodiments, said at least one polished surface has a reflectivity of at least 60%, or a reflectivity of at least 75%, or a reflectivity of at least 85%, or at least 90%, or at least 95%.

The one or more pistons 1102, valves 1101 and engine head 1104 have been defined to not be a part of the internal combustion chamber 1103 or chambers though the one or more pistons 1102 move within the chamber 1103.

The definitions and structural details that have been provided concerning the component 10 are applicable to the method 100 of the present invention. Likewise, the definitions and structural details stated in connection with the discussion about the method 100 are also applicable to the component 10.

Especially (but not necessarily only) in preferred embodiments in which the reflectivity of the polished surface is at least 90% or at least 95%, the polished surface may also have a thin coating of one or a combination of the following materials: polymer bonded composite of particles, glass, silica, sol-gel coating, silicon, titanium dioxide, nickel, chrome, gold, silver and platinum, and said polished surface. The thin coating is normally applied after the polishing is performed.

The component 10 may comprise an internal combustion chamber having an internal wall of the chamber, and the internal wall may have a first zone of the surface having a first reflectivity, the first zone not traversed by the one or more pistons, and may have a second zone of the surface traversed by the one or more pistons, the second zone having a second reflectivity. In one preferred embodiment, the first zone is cylindrical and the second zone is cylindrical.

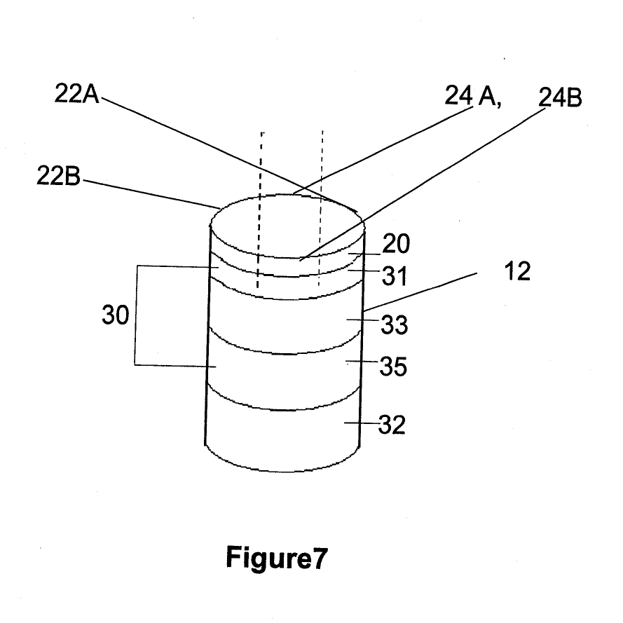

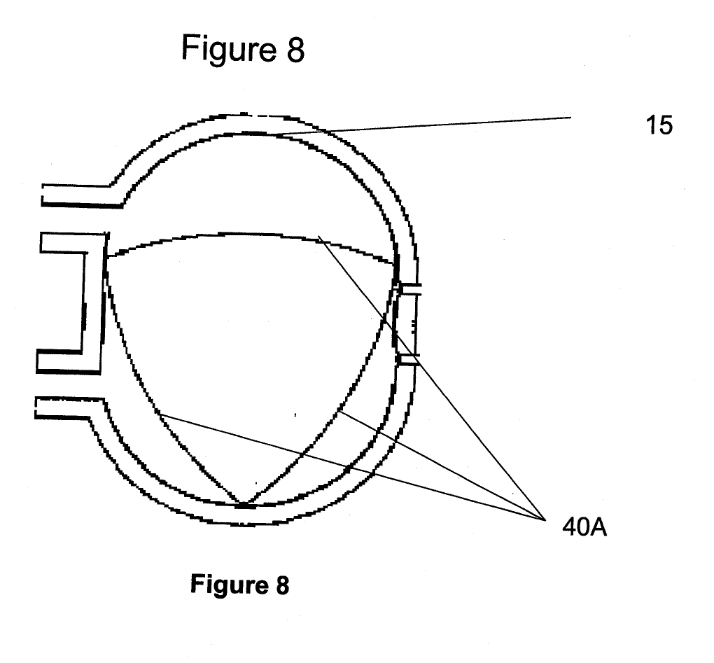

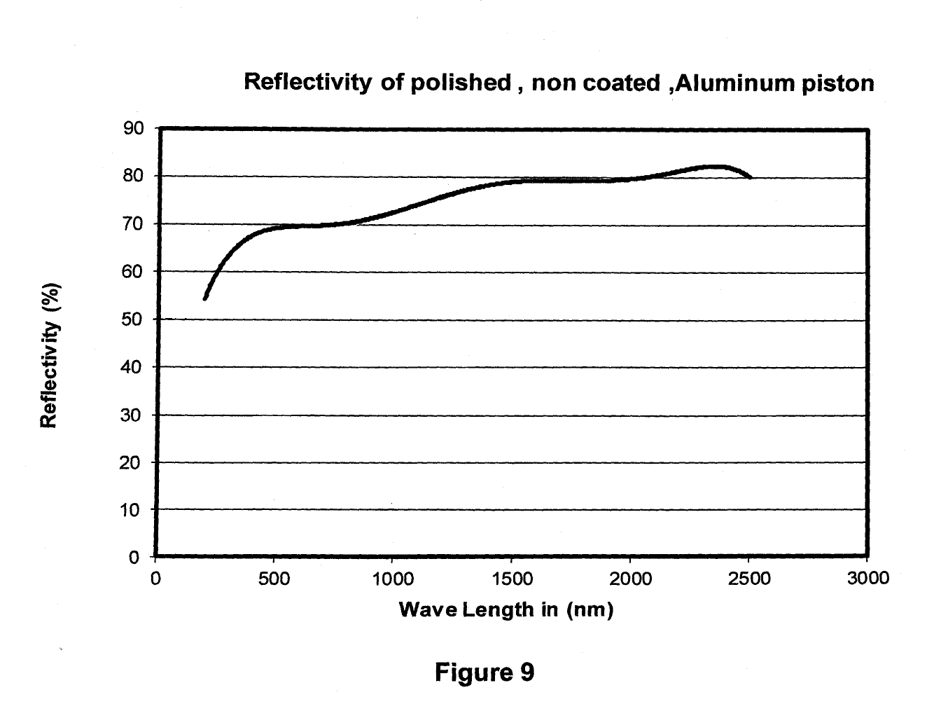

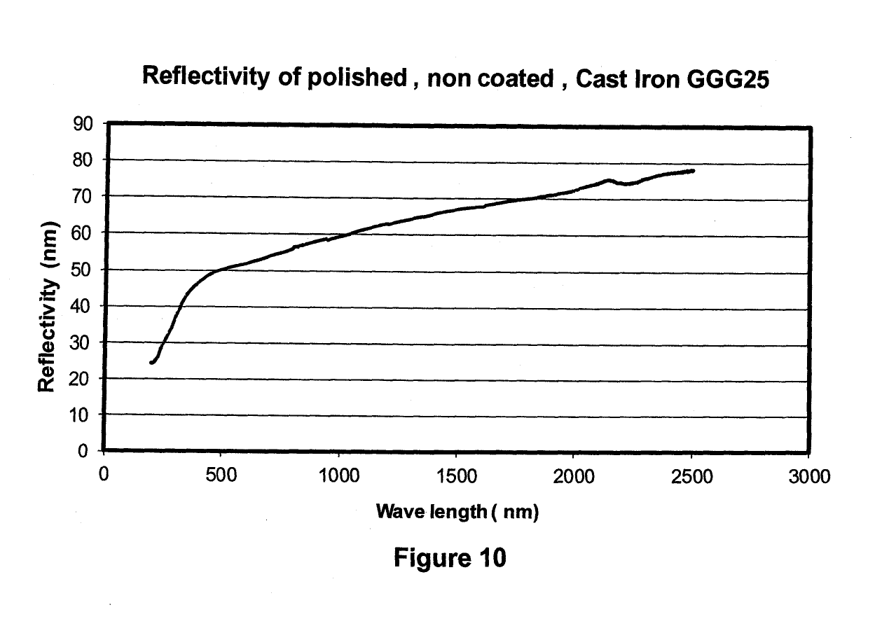

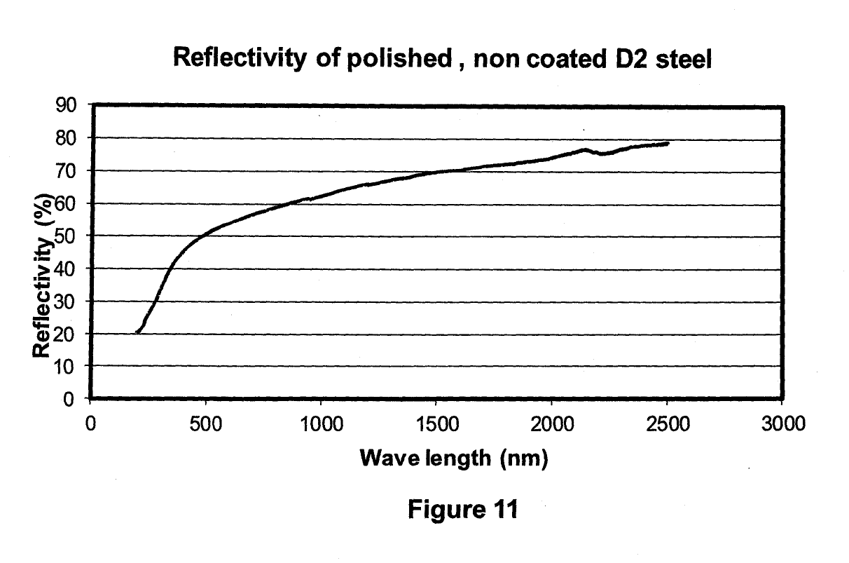

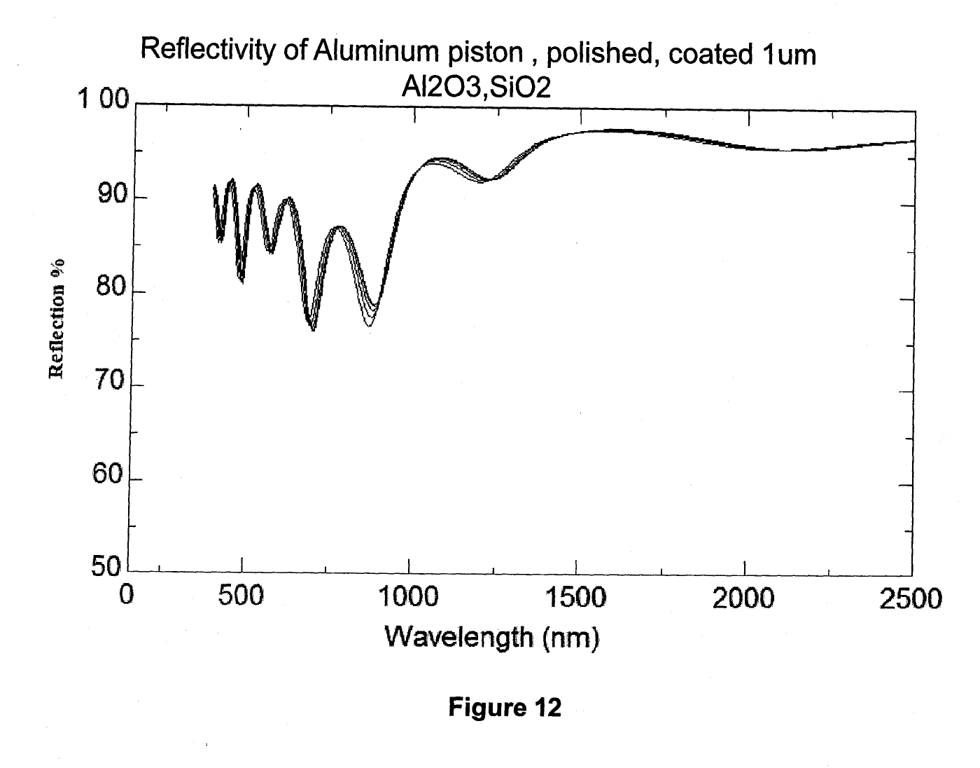

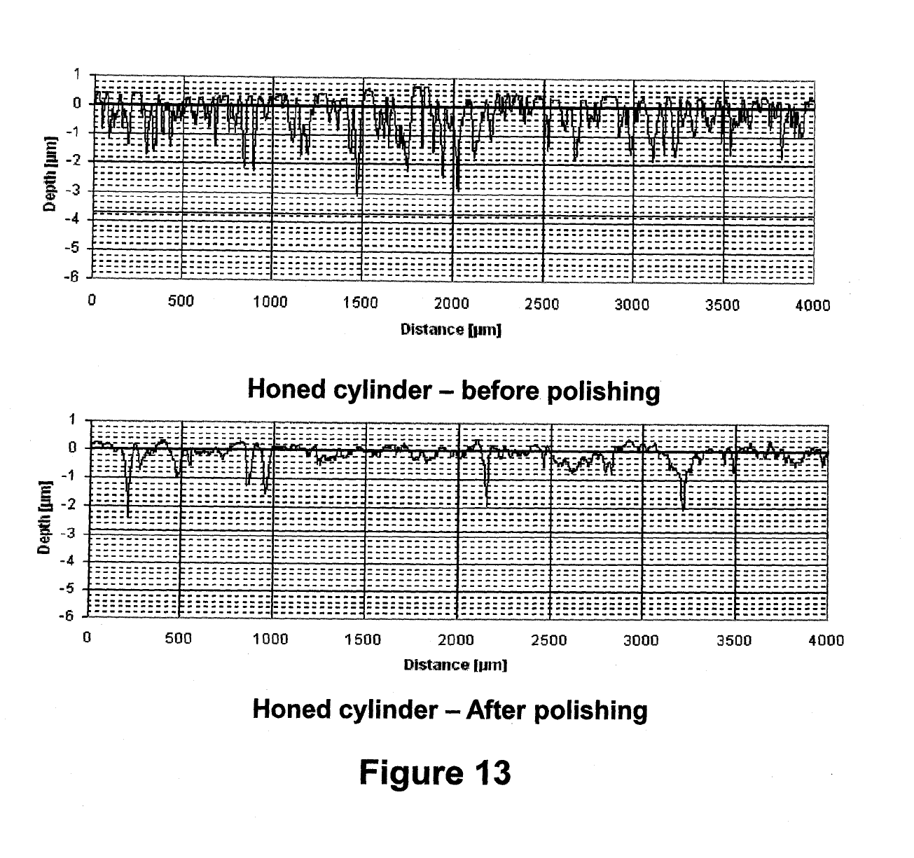

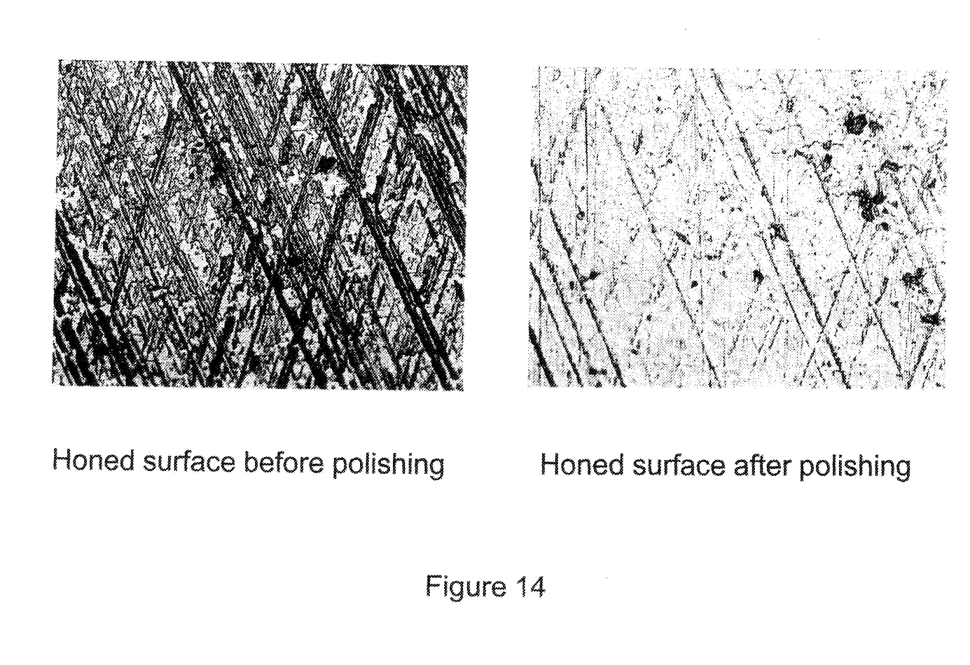

Typically, the piston of the one or more pistons of one chamber of an internal combustion engine operates identically to other pistons of the one or more pistons of another chamber within the same internal combustion engine, although the present invention is not limited to this circumstance. As seen from FIG. 6, while a first plane that may be substantially perpendicular to the cylinder wall may separate the first zone where the one or more pistons do not reach from the second zone that the one or more pistons do traverse. As seen from FIG. 7, a second plane that may be substantially parallel to the cylindrical wall may separate the first zone into a first subzone and a second subzone, wherein the first subzone and the second subzone differ in reflectivity or differ in surface roughness (and thereby also in reflectivity) or differ in wetting characteristics (and thereby in some cases also in reflectivity).

As a result of the tilting of the piston 1102 within the chamber 1103 relative to the longitudinal axis of the chamber which is the axis along which the piston generally moves), there may be a need to treat different rotational portions (for example a first and third arc) of the circumference of the chamber differently than other rotational portions (for example a second and fourth arc). Accordingly, as seen from FIG. 7, the first zone 20 is cylindrical and the first subzone 22A, 22B and second subzone 24A, 24B of the first zone 20 traverse different non-overlapping arcs of rotation of a circumference C of the cylinder of the first zone 20.

The second zone 30 may have a first subzone 33 that may have a second reflectivity and a second subzone 35 that may have a third reflectivity. In still other preferred embodiments, the second zone 30 has three or more subzones having three or more different reflectivities. The differences in reflectivity between first and second zones 20, 30 or between subzones of the first or second zone, is due to use of different amounts of pressure, different electrical current densities or voltages, or application of the pressure or electrical current density or voltage for different lengths of time, as described in regard to the method 100 of the present invention.

The second zone 30 may have three or more subzones which may have three or more different level of surface quality, wherein the surface quality is defined as roughness, Ra, or roughness and RΔq, for example with each subzone having a different surface quality, or a different roughness.

The polished surface has a thin coating of one or a combination of the following materials: polymer bonded composite of particles, glass, silica, sol-gel coating, silicon, titanium dioxide, nickel, chrome, gold, silver and platinum. The thin coating may have a thickness of between 15 nanometers and 65 microns. In other preferred embodiments, the thickness of the thin coating is as described in connection with the method 100.

Where the component 10 comprises the chamber 1103, the chamber being cylindrical and having an internal wall, the internal wall may contain honing marks left on the polished surface after the polishing. The surface of the component, between the honing marks left on the cylindrical internal wall after the polishing, may have a roughness, Ra, of less than 0.05 microns and an RΔq of less than 0.03. In other preferred embodiments, the roughness, Ra, may be less than 0.025 microns and the RΔq may be less than 0.03. In still other preferred embodiments, the roughness, Ra, may be less than 0.01 microns and the RΔq may be less than 0.02.

If one considers the honing marks remaining after polishing to define segments of the polished surface, then in certain preferred embodiments, the ratio between the area of the polished surface having a surface quality of N2 or less to the area of the polished surface having a surface quality of N3 and more is 0.5 or more, and more preferable more than 1.5. In measuring this ratio, only segments of 30 square microns of more are counted.

As noted, the heat loss from the combustion is directed to the combustion chamber walls by two principle mechanisms−30-35% by radiation and the rest by convection from the combustion products and friction. As of the nature of reciprocal combustion engines the pistons typically will receive much of the radiative heat flux ˜50%, the engine head & valves ˜30% and the cylinder ˜20% as it is gradually exposed throughout the cycle while the combustion gases lowers their temperature somewhat.

In order to optimize the treatments, the treatments take into consideration the fact that each of the areas to be treated are in most cases made of different materials (cylinders liners will be typically and commonly made of cast iron alloys, piston will be mostly made of aluminum, aluminum alloys or steel or stainless steel alloys, engine head will be typically made of aluminum for passenger cars engine or cast iron/steel for heavier applications where as valves will be mostly made of steel/chrome coated steel). Thus, the processing conditions and processing methods as well as potential coatings per each of the cases may be optimized.

The term “about” as used herein means plus or minus 5% of the number after the word “about”. For example, “about 100%” means between 95% and 105%. The word “piston” in the phrase one or more pistons includes reciprocating pistons as well as rotors that function as pistons (for example in rotary piston engines). Accordingly, the one or more pistons referred to herein may move linearly or may move non-linearly.

While the invention has been described with respect to a limited number of embodiments, it will be appreciated that many variations, modifications and other applications of the invention may be made. Therefore, the claimed invention as recited in the claims that follow is not limited to the embodiments described herein.

1. A method of improving the reflectivity of a surface of an internal combustion engine, the internal combustion engine having a cylindrical or non-cylindrical internal wall of an internal combustion chamber in which one or more pistons move and in which combustion occurs, the method comprising:
polishing a surface of the internal combustion chamber, said surface exposed to combustion during use of the internal combustion engine, wherein the surface is at least one of (i) the cylindrical internal wall of the internal combustion chamber, (ii) the one or more pistons, (iii) a valve and (iv) an engine head,
said polishing effective to increase a reflectivity of the surface,
further comprising
polishing a first zone of the surface using a first amount of pressure for a first length of time, the first zone not traversed by the one or more pistons, and
polishing a second zone of the surface traversed by the one or more pistons using an amount of pressure greater or lesser than the first amount of pressure or using the first amount of pressure for a length of time longer or shorter than the first length of time, wherein length of time refers to length of time that the surface is polished by a tool.

2.-3. (canceled)

4. The method of claim 1, where the first amount of pressure is at least 50 per cent greater than the amount of pressure used to polish the second zone.

5. The method of claim 1, further comprising polishing a first subzone of the second zone with a different amount of pressure or different electrical current density or voltage than a polishing of a second subzone of the second zone.

6. The method of claim 1, further comprising
polishing a first zone of the surface using a first amount of electrical current density or voltage for a first length of time, the first zone not traversed by the one or more pistons, and
polishing a second zone of the surface traversed by the one or more pistons either using an amount of electrical current density or voltage greater or lesser than the first amount of electrical current density or voltage or using the first amount of electrical current density or voltage for a length of time longer or shorter than the first length of time.

7. The method of claim 1, further comprising applying a thin coating of one or a combination of the following materials or layers thereof: polymer bonded composite of sub-micron particles, glass, silica, sol-gel coating, silicon, titanium dioxide, nickel, chrome, gold, silver, platinum and particles thereof.

8. The method of claim 7, wherein the thin coating has a thickness of between 15 nanometers and 65 microns.

9.-10. (canceled)

11. The method of claim 1, further comprising polishing the cylindrical internal wall of the internal combustion engine to have, between honing marks left on the cylindrical internal wall after the polishing, a roughness, Ra, of less than 0.05 microns and an RΔq of less than 0.03.

12.-14. (canceled)

15. The method of claim 1, wherein polishing the surface comprises polishing a surface of the one or more pistons exposed to combustion so as to increase the reflectivity to more than 45%.

16.-19. (canceled)

20. The method of claim 1, wherein polishing the surface comprises polishing a surface of the one or more pistons exposed to combustion by using a tool having conformal surface that deforms according to work piece geometry.

21. The method of claim 20, further comprising polishing using the tool wherein the tool has abrasive paste, said paste containing abrasive particles and containing any combination of etching compound, binding agents, thickeners and polymer particles.

22. The method of claim 20, further comprising polishing using the tool so as to apply electrical current to the surface.

23. The method of claim 1, wherein polishing the surface comprises polishing a surface of the one or more pistons exposed to combustion by using a polymer tool having Young modulus lower than 20 GPa and having conformal surface that deforms according to work piece geometry structure.

24. The method of claim 1, wherein polishing the surface comprises polishing a surface of the one or more pistons exposed to combustion using a polymer tool containing supporting layers of-activated at a speed below 10 m/sec at an initial stage and below 17.5 m/sec at a final stage, said polymer tool pressed to the surface with pressure higher than 0.005 Mpa at the initial stage and lower than 0.35 MPa at the final stage.

25. A component of an internal combustion engine, the engine having a chamber that has a cylindrical- or non-cylindrical internal wall and has one or more pistons moving within the chamber, the component including one of the following: (i) an internal combustion chamber having an internal wall including a polished surface exposed to combustion during operation of the engine, (ii) one or more pistons that have a polished surface exposed to combustion during operation of the engine, (iii) a valve having a polished surface exposed to combustion during operation of the engine and (iv) an engine head having a polished surface exposed to combustion during operation of the engine, said polished surface having a reflectivity of at least 45%,
wherein the component comprises the internal combustion chamber whose internal wall has a first zone of the surface having a first reflectivity, the first zone not traversed by the one or more pistons, and having a second zone of the surface traversed by the one or more pistons, the second zone having a second reflectivity.

26.-29. (canceled)

30. The component of claim 25, wherein said polished surface has a reflectivity of at least 95%.

31. (canceled)

32. The component of claim 25, wherein the first zone is cylindrical and the second zone is cylindrical.

33. The component of claim 25, wherein a first plane separates the first zone from the second zone, wherein a second plane separates the first zone into a first subzone and a second subzone and wherein the first subzone and the second subzone differ in reflectivity.

34. The component of claim 25, wherein the first zone is cylindrical and the first and second subzones traverse different non-overlapping arcs of rotation of a circumference of the cylinder of the first zone.

35. The component of claim 25, wherein the second zone has a first subzone having the second reflectivity and a second subzone having a third reflectivity.

36. The component of claim 25, wherein the second zone three or more subzones having three or more different reflectivities.

37. The component of claim 25, wherein the second zone has three or more subzones having three or more different level of roughness.

38. The component of claim 25, wherein the polished surface has a thin coating of one or a combination of the following materials: polymer bonded composite of particles, glass, silica, sol-gel coating, silicon, titanium dioxide, nickel, chrome, gold, silver and platinum.

39. The component of claim 38, wherein the thin coating has a thickness of between 15 nanometers and 65 microns.

40. The component of claim 38, wherein the thin coating has a thickness of between 15 nanometers and 1 micron.

41. The component of claim 25, wherein internal combustion chamber is cylindrical, the internal wall of the chamber containing honing marks left on the polished surface, and wherein the surface has a roughness, Ra, of less than 0.05 microns between the honing marks and an RΔq, of less than 0.03.

42.-43. (canceled)

44. The component of claim 25, wherein a ratio between the area of the polished surface having a surface quality of N2 or less to the area of the polished surface having a surface quality of N3 and more is 0.5 or more, wherein only segments of 30 square microns of more are counted in measuring the ratio.

45. (canceled)
